(19) United States
(12) Patent Application Publication
(10) Pub. No.: US 2026/0155081 A1
(43) Pub. Date: Jun. 4, 2026

(54) DRIVING DEVICE FOR DRIVING DISPLAY PANEL

(71) Applicant: Novatek Microelectronics Corp., Hsinchu (TW)

(72) Inventors: Grace Li, Taipei City (TW); Ying-Chung Tseng, Tainan City (TW); Yen-Tao Liao, Hsinchu City (TW)

(73) Assignee: Novatek Microelectronics Corp., Hsinchu (TW)

(21) Appl. No.: 19/082,182

(22) Filed: Mar. 18, 2025

(30) Foreign Application Priority Data
Nov. 29, 2024 (TW) 113146192

(51) Int. Cl. G09G 3/20; G09G 3/34

(52) U.S. Cl. CPC G09G 3/2092; G09G 3/3406; G09G 2310/0291; G09G 2320/0257; G09G 2320/0626

(57) ABSTRACT

A driving device is provided. The driving device includes a driver and a timing controller (TCON). The driver is coupled to a pixel circuit and a backlight circuit of a display panel. The TCON is coupled to the driver. In a frame cycle, after a delayed interval, the TCON outputs output image data to the driver, such that the driver drives the pixel circuit and the backlight circuit according to the output image data and backlight image data at the same time. Alternatively, when the driver drives the pixel circuit, after an interval based on dummy data of the backlight image data, the driver drives the backlight circuit according to available data of the backlight image data.

### CROSS-REFERENCE TO RELATED APPLICATION

This application claims the priority benefit of Taiwan application serial no. 113146192, filed on Nov. 29, 2024. The entirety of the above-mentioned patent application is hereby incorporated by reference herein and made a part of this specification.

### BACKGROUND

### Technical Field

The disclosure relates to a driving device, and in particular relates to a driving device for driving a display panel.

### Description of Related Art

Generally speaking, display panels may apply local dimming technology to achieve power saving effects. For a specific display area, the display panel may calculate the display data and backlight data required for this display area in each frame cycle through a driving device.

However, the current driving device requires the completion of display data calculation for a single frame cycle before proceeding with the calculation of the corresponding backlight data. In this way, in the same frame cycle, the currently operated display data and backlight data have a delay difference of at least one frame cycle and do not match each other, so that afterimages such as backlight smear or backlight flicker appear on the display screen of the display panel.

### SUMMARY

A driving device that may prevent afterimages on a display screen during local dimming application is provided in an embodiment of the disclosure. driving device according to the embodiment of the disclosure is suitable for driving a display panel. The driving device includes a driver and a timing controller. The driver is coupled to a pixel circuit and a backlight circuit of the display panel. The timing controller is coupled to the driver. The timing controller includes a buffer. The buffer is configured to store input image data corresponding to at least one area of the display panel during a frame cycle. The timing controller is configured to output the output image data to the driver according to the input image data after a delayed interval. In this way, the driver simultaneously drives a pixel circuit according to the output image data and drives the backlight circuit according to backlight image data generated based on the input image data.

An embodiment of the disclosure further provides a driving device. The driving device is suitable for driving a display panel. The driving device includes a driver and a timing controller. The driver is coupled to a pixel circuit and a backlight circuit of the display panel. The timing controller is coupled to the driver. The timing controller is configured to calculate backlight image data and output image data according to input image data corresponding to at least one area of the display panel during a frame cycle. The backlight image data includes dummy data and valid data. In the frame cycle, when the driver drives the pixel circuit according to the output image data, the driver drives the backlight circuit according to the valid data after an interval based on the dummy data.

Based on the above, the driving device of the embodiment of the disclosure provides output image data to the driver after a delayed interval through the timing controller, or generates backlight image data including dummy data through the timing controller, and the driver may receive output image data and backlight image data corresponding to the same frame cycle. In this way, the driving device may drive the display panel according to these matching image data to achieve the application of local dimming, thereby preventing afterimages on the display screen of the display panel.

In order to make the above-mentioned features and advantages of the disclosure comprehensible, embodiments accompanied with drawings are described in detail below.

### BRIEF DESCRIPTION OF THE DRAWINGS

FIG. 1A is a circuit block diagram of a display device according to an embodiment of the disclosure.

FIG. 1B is a circuit block diagram of a driving device according to the embodiment of FIG. 1A of the disclosure.

FIG. 2 is a circuit block diagram of a driving device according to another embodiment of the disclosure.

FIG. 3 is a schematic diagram of the operation of the driving device according to the embodiment of FIG. 2 of the disclosure.

FIG. 4 is a circuit block diagram of a driving device according to another embodiment of the disclosure.

FIG. 5 is a schematic diagram of the operation of the driving device according to the embodiment of FIG. 4 of the disclosure.

FIG. 6 is a circuit block diagram of a driving device according to an embodiment of the disclosure.

FIG. 7 is a circuit block diagram of a driving device according to another embodiment of the disclosure.

FIG. 8 is a schematic diagram of the operation of the driving device according to the embodiment of FIG. 7 of the disclosure.

### DETAILED DESCRIPTION OF DISCLOSED EMBODIMENTS

A portion of the embodiments of the disclosure will be described in detail with reference to the accompanying drawings. Element symbol referenced in the following description will be regarded as the same or similar element when the same element symbol appears in different drawings. These examples are only a portion of the disclosure and do not disclose all possible embodiments of the disclosure. More precisely, these embodiments are only examples within the scope of the patent application of the disclosure.

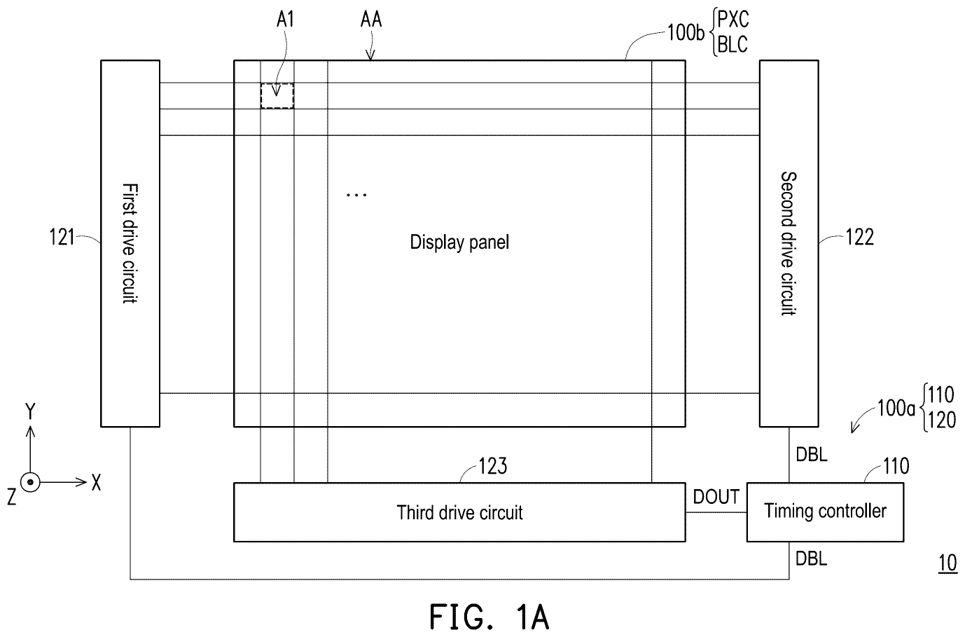

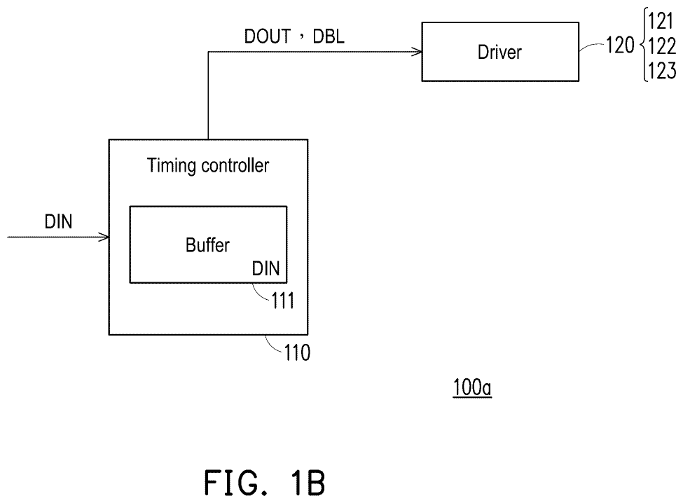

FIG. 1A is a circuit block diagram of a display device according to an embodiment of the disclosure. Referring to FIG. 1A, the display device 10 may be, for example, a liquid crystal display (LCD). The display device 10 may apply local dimming technology. The display device 10 includes a driving device 100a and a display panel 100b. The driving device 100a is coupled to the display panel 100b. The driving device 100a is configured to drive the display panel 100b.

In this embodiment, the display panel 100b includes a pixel circuit PXC and a backlight circuit BLC. The pixel circuit PXC is disposed in the active area AA of the display panel 100b. The pixel circuit PXC includes multiple pixel units (not shown). These pixel units are arranged in an array and have the same circuit architecture. The pixel unit may be, for example, an LCD or other display element that provides a display function.

In this embodiment, the backlight circuit BLC is disposed in the active area AA and overlaps the pixel circuit PXC in the Z direction. The backlight circuit BLC includes multiple backlight units (not shown). These backlight units are arranged in an array and have the same circuit architecture. The backlight unit may be, for example, a cold cathode fluorescent lamp (CCFL), a light emitting diode (LED), or other display element that provides a display function.

Referring concurrently to FIG. 1B, FIG. 1B is a circuit block diagram of a driving device according to the embodiment of FIG. 1A of the disclosure. The driving device 100a includes a timing controller 110 and a driver 120. The driver 120 is coupled to the timing controller 110. The driver 120 includes multiple driving circuits 121 to 123. Based on the data and/or signals of the timing controller 110 (e.g., including the output image data DOUT and the backlight image data DBL), these driving circuits 121 to 123 are configured to drive multiple pixel units and multiple backlight units in one or more areas (e.g., the area A1) in the display panel 100b to achieve local dimming.

In detail, the driver 120 is coupled to the backlight circuit BLC through the first driving circuit 121 and the second driving circuit 122. The driving circuits 121 to 122 are respectively disposed on two sides of the display panel 100b relative to the X direction, and are coupled to the timing controller 110. The driving circuits 121 to 122 are configured to drive the backlight circuit BLC according to the backlight image data DBL. These driving circuits 121 to 122 may be, for example, backlight driving circuits.

In addition, the driver 120 is coupled to the pixel circuit PXC through the third driving circuit 123. The third driving circuit 123 is coupled to the timing controller 110. The third driving circuit 123 is configured to drive the pixel circuit PXC according to the output image data DOUT. The third driving circuit 123 may be, for example, a pixel driving circuit.

In this embodiment, the timing controller 110 includes a buffer 111. The buffer 111 is configured to temporarily store data required by the timing controller 110 during operation. The capacity of the buffer 111 may be determined based on the design requirements of the driving device 100a.

During the local dimming operation, the timing controller 110 receives the input image data DIN of a single frame cycle. The buffer 111 stores the input image data DIN. In a single frame cycle, the timing controller 110 generates the output image data DOUT according to the input image data DIN after a delayed interval. Then, the timing controller 110 outputs the output image data DOUT to the driver 120.

In this embodiment, the input image data DIN may be, for example, grayscale data corresponding to at least one area (e.g., the area A1) of the display panel 100b in a single frame cycle. The output image data DOUT may be, for example, the grayscale data configured by the driver 120 to drive the pixel circuit PXC in this frame cycle, and corresponds to the same area (e.g., the area A1) as the input image data DIN.

In addition, during the local dimming operation, in a single frame cycle, the timing controller 110 further generates the backlight image data DBL according to the input image data DIN. The backlight image data DBL may be, for example, the grayscale data configured by the driver 120 to drive the backlight circuit BLC in this frame cycle, and corresponds to the same area (e.g., the area A1) as the input image data DIN.

In this way, the driver 120 receives the output image data DOUT and the backlight image data DBL required in the same frame cycle. The driver 120 simultaneously drives the pixel circuit PXC according to the output image data DOUT, and drives the backlight circuit BLC according to the backlight image data DBL generated based on the input image data DIN.

It is worth mentioning that since the buffer 111 temporarily stores the input image data DIN for a single frame cycle, the timing controller 110 may access the input image data DIN and generate the output image data DOUT and the backlight image data DBL accordingly. That is, the aforementioned output image data DOUT and backlight image data DBL are grayscale data required in the same frame cycle and match each other. In addition, in a single frame cycle, the timing controller 110 may provide the output image data DOUT to the driver 120 after a delayed interval, instead of immediately outputting the corresponding output image data DOUT to the driver 120 in response to the received input image data DIN.

In this way, the driving device 100a may prevent the image data DOUT and DBL received by the driver 120 from having a delay difference of one or more frame cycles. That is, the driver 120 may operate according to the output image data DOUT and the backlight image data DBL matching in the same frame cycle. Therefore, in the application of local dimming, the driving device 100a may prevent afterimages from appearing on the display image of the display panel 100b due to the mismatched image data DOUT and DBL.

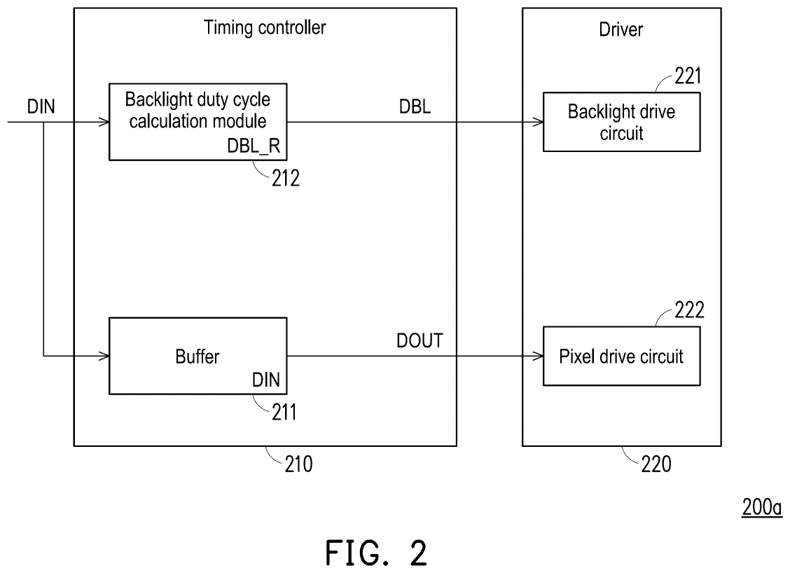

FIG. 2 is a circuit block diagram of a driving device according to another embodiment of the disclosure. Referring to FIG. 2, the driving device 200a includes a timing controller 210 and a driver 220. The timing controller 210 includes a buffer 211. The driver 220 includes a backlight driving circuit 221 and a pixel driving circuit 222. The timing controller 210, the driver 220, the buffer 211, the backlight driving circuit 221 and the pixel driving circuit 222 may be understood by reference to the relevant descriptions of the driving device 100a.

In the embodiment of FIG. 2, the timing controller 210 further includes a backlight duty cycle calculation module 212. The backlight duty cycle calculation module 212 may be, for example, implemented in firmware or software, and has access and calculation functions.

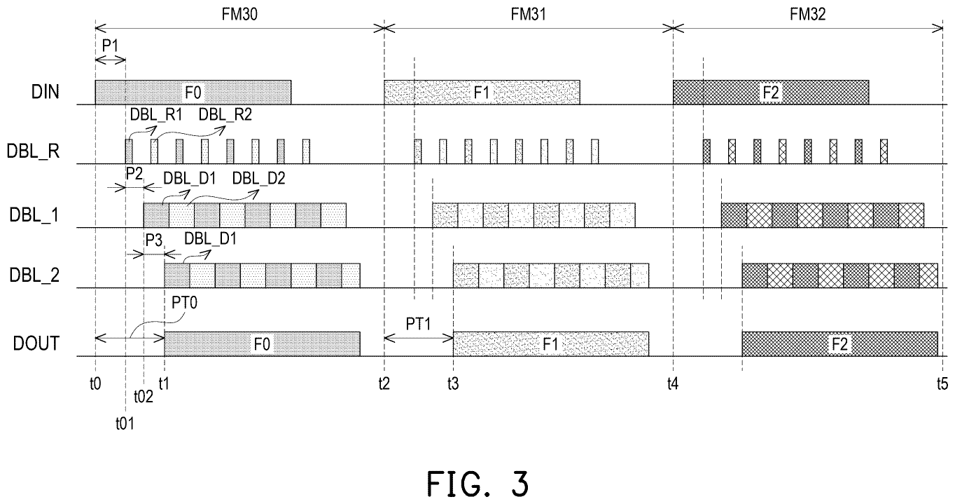

Referring concurrently to FIG. 3, FIG. 3 is a schematic diagram of the operation of the driving device according to the embodiment of FIG. 2 of the disclosure. In FIG. 3, the horizontal axis represents the operation time of the driving device 200a, and the vertical axis represents the voltage values of various data and/or signals of the driving device 200a.

In the embodiments of FIG. 2 and FIG. 3, in each frame cycle FM30 to FM32, the driving device 200a sequentially drives a single area of the display panel (e.g., the area A1 shown in FIG. 1A) according to various image data DOUT and DBL required for multiple rows in this area, to achieve the application of local dimming.

In the frame cycle FM30 (i.e., time t0 to t2), at time t0, the timing controller 210 receives input image data DIN (i.e., image data represented by “F0”). At this time, the buffer 211 temporarily stores the input image data DIN. In addition, the timing controller 210 calculates the backlight duty cycle data DBL_R according to the input image data DIN through the backlight duty cycle calculation module 212 to generate the backlight image data DBL.

Specifically, at time t0, the backlight duty cycle calculation module 212 starts to calculate the output of the backlight duty cycle data DBL_R. At time t01, the backlight duty cycle calculation module 212 completes the calculation operation to output the backlight duty cycle data DBL_R. The backlight duty cycle data DBL_R may be, for example, a part of the backlight image data DBL.

In this embodiment, the backlight duty cycle data DBL_R includes multiple sub-duty cycle data (e.g., including sub-duty cycle data DBL_R1 and DBL_R2) in a single area (e.g., the area A1 shown in FIG. 1A). These sub-duty cycle data respectively indicate multiple duty cycles of multiple backlight units disposed on adjacent and different rows in the area A1.

For example, taking the area A1 shown in FIG. 1A as an example, the sub-duty cycle data DBL_R1 indicates the duty cycles of multiple backlight units disposed on the first row in the area A1. The sub-duty cycle data DBL_R2 indicates the duty cycles of the backlight units disposed on the second row in the area A1, and so forth.

In the frame cycle FM30, at time t01, the timing controller 210 transmits the generated backlight image data DBL to the driver 220. Next, the driver 220 drives the backlight circuit (e.g., the backlight circuit BLC shown in FIG. 1A) according to the backlight image data DBL.

Specifically, at time t01, the timing controller 210 outputs the backlight duty cycle data DBL_R and the backlight image data DBL to the driver 220.

At time t02, the driver 220 receives the above-mentioned image data DBL_R and DBL. The aforementioned received image data DBL_R and DBL may be, for example, represented by backlight image data “DBL_1”. In addition, the driver 220 further outputs the received backlight image data DBL (i.e., backlight image data “DBL_1”) to the backlight driving circuit 221.

At time t1, the backlight driving circuit 221 receives the above-mentioned backlight image data DBL. The aforementioned received backlight image data DBL may be, for example, represented by backlight image data “DBL_2”. In addition, the backlight driving circuit 221 is enabled to drive the backlight circuit (e.g., the backlight circuit BLC shown in FIG. 1A) according to the backlight image data DBL (i.e., the backlight image data “DBL_2”).

It should be noted that in the frame cycle FM30, after a delayed interval (i.e., the interval PT0) starting from time t0, that is, at time t1, the driver 220 drives the backlight circuit according to the received backlight image data DBL (i.e., the backlight image data “DBL_2”) through the backlight driving circuit 221.

At the same time, at time t1, the timing controller 210 accesses the buffer 211 to obtain the input image data DIN. The timing controller 210 takes the input image data DIN as the output image data DOUT (i.e., the image data represented by “F0”), and transmits the output image data DOUT to the driver 220. In this way, at time t1, the driver 220 further receives the output image data DOUT through the pixel driving circuit 222, and enables the driving of the pixel circuit (e.g., the pixel circuit PXC shown in FIG. 1A) based on the output image data DOUT.

That is, at time t1, in addition to driving the backlight circuit according to the backlight image data DBL, the driver 220 further simultaneously drives the pixel circuit according to the output image data DOUT. These image data DBL and DOUT indicate the grayscale data required for the same frame cycle FM30 (i.e., the image data represented by “DIN_0”), and indicate that multiple backlight units and multiple pixel units disposed in the same area respectively emit corresponding light. Therefore, at time t1, the backlight image data DBL and the output image data DOUT operated by the driver 220 match each other.

In this embodiment, the delayed interval PT0 in the frame cycle FM30 is smaller than the single frame cycle FM30. Specifically, the delayed interval PT0 includes multiple intervals P1 to P3. The interval P1 (i.e., time t0 to t01) may be, for example, the time duration which the backlight duty cycle calculation module 212 calculates the backlight duty cycle data DBL_R.

In this embodiment, the interval P2 (i.e., time t01 to t02) may be, for example, the time duration which the timing controller 210 transmits the calculated backlight duty cycle data DBL_R and the backlight image data DBL to the driver 220. That is, the interval P2 includes the transmission time for the timing controller 210 to output the backlight duty cycle data DBL_R and the backlight image data DBL to the driver 220 and the reaction time required for the driver 220 to receive the aforementioned data DBL_R and DBL. In this way, at time t02, the driver 220 obtains the backlight image data DBL including the backlight duty cycle data DBL_R (i.e., the backlight image data “DBL_1”).

In this embodiment, the interval P3 (i.e., time t02 to t1) may be, for example, the time duration which the driver 220 transmits the backlight image data DBL to the backlight circuit to enable the backlight circuit. That is, the interval P3 includes the transmission time for the backlight driving circuit 221 to output the backlight image data DBL to the backlight circuit, and the reaction time required for the backlight circuit to be lit based on the backlight image data DBL. In this way, at time t1, the backlight driving circuit 221 starts driving the backlight circuit according to the backlight image data DBL including the backlight duty cycle data DBL_R (i.e., the backlight image data “DBL_2”).

It should be noted that since the buffer 211 has pre-stored the input image data DIN required for the frame cycle FM30 (i.e., the image data represented by “F0”), the timing controller 210 may provide the output image data DOUT according to the input image data DIN after a delay interval PT0 (i.e., at time t1). In this way, at time t1, the driver 220 may simultaneously operate according to the matching backlight image data DBL (i.e., the backlight image data “DBL_2”) and the output image data DOUT, thereby achieving a synchronization effect of local dimming.

In this embodiment, the operation of the driving device 200a in other frame cycle FM31 (i.e., time t2 to t4) and frame cycle FM32 (i.e., time t4 to t5) may be understood by reference to the relevant descriptions of the frame cycle FM30.

In this embodiment, the timing controller 210 sets the delayed interval (e.g., the interval PT0 or PT1) according to the input image data DIN required for each frame cycle FM30 to FM32. In other embodiments, the delayed intervals PT0 and PT1 are the same preset interval.

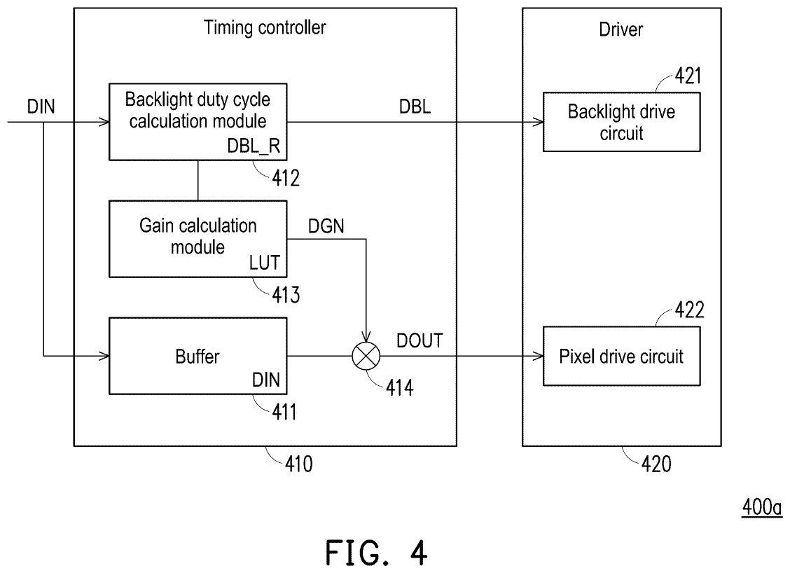

FIG. 4 is a circuit block diagram of a driving device according to another embodiment of the disclosure. Referring to FIG. 4, the driving device 400a includes a timing controller 410 and a driver 420. The timing controller 410 includes a buffer 411. The driver 420 includes a backlight driving circuit 421 and a pixel driving circuit 422. The timing controller 410, the driver 420, the buffer 411, the backlight driving circuit 421 and the pixel driving circuit 422 may be understood by reference to the relevant descriptions of the driving device 100a.

In the embodiment of FIG. 4, the timing controller 410 further includes a backlight duty cycle calculation module 412, a gain calculation module 413, and a multiplier 414. The backlight duty cycle calculation module 412 may be understood by reference to the relevant descriptions of the backlight duty cycle calculation module 212. The gain calculation module 413 and the multiplier 414 may be respectively implemented by, for example, firmware or software, and have access and calculation functions.

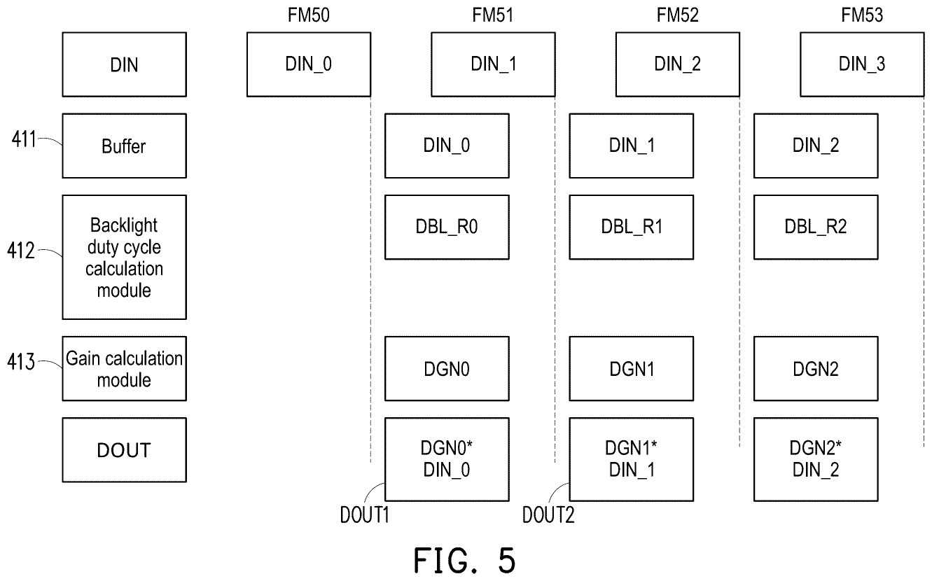

Referring concurrently to FIG. 5, FIG. 5 is a schematic diagram of the operation of the driving device according to the embodiment of FIG. 4 of the disclosure. In FIG. 5, the horizontal axis represents the operation time of the driving device 400a, and the vertical axis represents various data and/or module examples of the driving device 400a.

Compared with the embodiments of FIG. 2 and FIG. 3, in the embodiments of FIG. 4 and FIG. 5, the driving device 400a drives at least one area of the display panel (e.g., the area A1 shown in FIG. 1A) according to various image data DOUT and DBL required for each complete frame cycle FM50 to FM53, to achieve the application of local dimming.

In the frame cycle FM50, the timing controller 410 receives input image data DIN (i.e., image data represented by “DIN_0”).

In the frame cycle FM51 after the frame cycle FM50, the timing controller 410 receives the input image data DIN (i.e., image data represented by “DIN_1”). At this time, the buffer 411 stores (i.e., temporarily stores) the input image data DIN (i.e., the image data represented by “DIN_0”) in the frame cycle FM50. In addition, the timing controller 410 calculates the backlight duty cycle data DBL_R (i.e., data represented by “DBL_R0”) according to the input image data DIN (i.e., image data represented by “DIN_0”) through the backlight duty cycle calculation module 412 to generate the backlight image data DBL. The backlight duty cycle data DBL_R may be, for example, a part of the backlight image data DBL.

In the frame cycle FM51, the timing controller 410 calculates the output image data DOUT according to the compensation lookup table LUT, the input image data DIN, and the backlight duty cycle data DBL_R through the gain calculation module 413 and the multiplier 414.

In this embodiment, the compensation lookup table LUT includes the corresponding relationship between the backlight image data DBL and the gain data DGN. That is, the compensation lookup table LUT indicates the corresponding relationship between the backlight duty cycle and the gain value, where the gain value indicates the compensation of the grayscale value corresponding to the backlight duty cycle.

Specifically, in the frame cycle FM51, the gain calculation module 413 accesses the compensation lookup table LUT and the calculated backlight duty cycle data DBL_R (i.e., data represented by “DBL_R0”). In addition, the gain calculation module 413 calculates the gain data DGN (i.e., data represented by “DGN0”) according to the compensation lookup table LUT and the backlight duty cycle data DBL_R.

Continuing the above description, in the frame cycle FM51, the timing controller 410 accesses the buffer 411 to obtain the input image data DIN (i.e., image data represented by “DIN_0”), instead of directly accessing the input image data DIN (i.e., image data represented by “DIN_1”) received in the frame cycle FM51.

In addition, in the frame cycle FM51, the multiplier 414 performs a multiplication operation on the gain data DGN (i.e., data represented by “DGN0”) and the input image data DIN (i.e., image data represented by “DIN_0”) to generate an output image data DOUT (i.e., output image data “DOUT1” represented by “DGN0*DIN_0”).

The the frame cycle FM51, the timing controller 410 transmits the backlight image data DBL (including data represented by “DBL_R0”) and the output image data DOUT (i.e., the output image data “DOUT1”) to the driver 420. In this way, the driver 420 drives the backlight circuit (e.g., the backlight circuit BLC shown in FIG. 1A) according to the backlight image data DBL through the backlight driving circuit 421. The driver 420 further drives the pixel circuit (e.g., the pixel circuit PXC shown in FIG. 1A) according to the output image data DOUT through the pixel driving circuit 222.

That is, in the frame cycle FM50, the timing controller 410 outputs the backlight image data DBL (including data represented by “DBL_R0”) and the output image data DOUT (i.e., output image data “DOUT1”) in the next frame cycle FM51 after a delayed interval. These image data DBL and DOUT indicate the grayscale data required for the same frame cycle FM50 (i.e., the image data represented by “DIN_0”), and indicate that multiple backlight units and multiple pixel units disposed in the same area respectively emit corresponding light. Therefore, in the same frame cycle FM51, the backlight image data DBL and the output image data DOUT operated by the driver 420 match each other.

In this embodiment, the aforementioned delayed interval is equal to a single frame cycle (e.g., the frame cycle FM50).

It should be noted that since the buffer 411 has pre-stored the input image data DIN required for the frame cycle FM50 (i.e., the image data represented by “F0”), the timing controller 210 may calculate the corresponding backlight image data DBL (including data represented by “DBL_R0”), gain data DGN (i.e., data represented by “DGN0”) and output image data DOUT (i.e., the output image data “DOUT1”) according to this input image data DIN after a delayed interval (i.e., during the frame cycle FM51). Therefore, the driving device 400a may prevent the image data DBL and DOUT from having a delay difference of one or more frame cycles.

In this way, in the frame cycle FM51, the driver 420 may simultaneously operate according to the matching backlight image data DBL (including data represented by “DBL_R0”) and the output image data DOUT (i.e., the output image data “DOUT1”), thereby achieving the synchronization effect of local dimming.

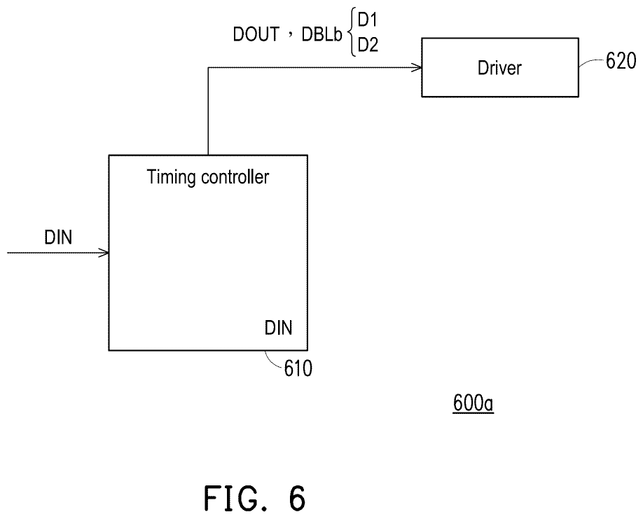

FIG. 6 is a circuit block diagram of a driving device according to an embodiment of the disclosure. Referring to FIG. 6, the driving device 600a may be applied to the display device 10 in FIG. 1A. The driving device 600a is configured to drive the display panel 100b shown in FIG. 1A, and is particularly suitable for driving multiple pixel units and multiple backlight units in one or more areas (e.g., the area A1) in the display panel 100b to achieve local dimming.

In this embodiment, the driving device 600a includes a timing controller 610 and a driver 620. The timing controller 610 is coupled to the driver 620. The driver 620 is coupled to the pixel circuit PXC and the backlight circuit BLC shown in FIG. 1A. Based on the data and/or signals of the timing controller 610 (e.g., including the output image data DOUT and the backlight image data DBLb), the driver 620 drives the pixel circuit PXC and the backlight circuit BLC.

During the local dimming operation, the timing controller 610 receives the input image data DIN of a single frame cycle. In a single frame cycle, the timing controller 610 calculates the output image data DOUT and the backlight image data DBLb required in this frame cycle according to the input image data DIN. Then, the timing controller 610 outputs the image data DOUT and DBLb to the driver 620, so that the driver 620 drives the target area according to the image data DOUT and DBLb.

In this embodiment, the input image data DIN may be, for example, grayscale data corresponding to at least one area (e.g., the area A1 shown in FIG. 1A) of the display panel in a single frame cycle. The output image data DOUT may be, for example, the grayscale data configured by the driver 620 to drive the pixel circuit in this frame cycle, and corresponds to the same area as the input image data DIN.

In this embodiment, the backlight image data DBLb includes dummy data D1 and valid data D2. These data D1 and D2 correspond to the same area as the input image data DIN. The dummy data D1 may be, for example, the grayscale data configured by the driver 620 not to drive the backlight circuit disposed in this area in a single frame cycle, and indicates that the backlight units disposed in this area do not emit light. The valid data D2 may be, for example, the grayscale data configured by the driver 620 to drive the backlight circuit disposed in this area in this frame cycle, and indicates that the backlight units disposed in this area emit light.

In this way, the driver 620 receives the output image data DOUT and the backlight image data DBLb required in the same frame cycle. The driver 620 simultaneously drives the pixel circuit according to the output image data DOUT, and drives the backlight circuit according to the backlight image data DBLb.

In this embodiment, in a single frame cycle, when the driver 620 drives the pixel circuit according to the output image data DOUT, the driver 620 does not drive the backlight circuit within a corresponding interval based on the dummy data D1 in the backlight image data DBLb. In this way, the corresponding backlight unit in the target area (e.g., the area A1 shown in FIG. 1A) exhibits a fully black effect. Then, after the aforementioned interval, the driver 620 drives the backlight circuit according to the valid data D2 in the backlight image data DBLb, so that the backlight unit in this area emits light.

It is worth mentioning that since the backlight image data DBLb includes dummy data D1, the driver 620 is capable of not driving the backlight circuit for an interval based on the dummy data D1. In this way, the driving device 600a may prevent the backlight image data applied in the previous frame cycle from remaining and affecting the operation of the present pixel circuit.

That is, the driving device 600a may prevent the output image data DOUT and the backlight image data DBLb from having a delay difference of one or more frame cycles during at least part of the interval of the frame cycle. In this way, the driver 620 may operate according to the output image data DOUT and the backlight image data DBLb matching in the same frame cycle during other intervals of the frame cycle. Therefore, in the application of local dimming, the driving device 600a may prevent afterimages from appearing on the display image of the display panel due to the mismatched image data DOUT and DBLb.

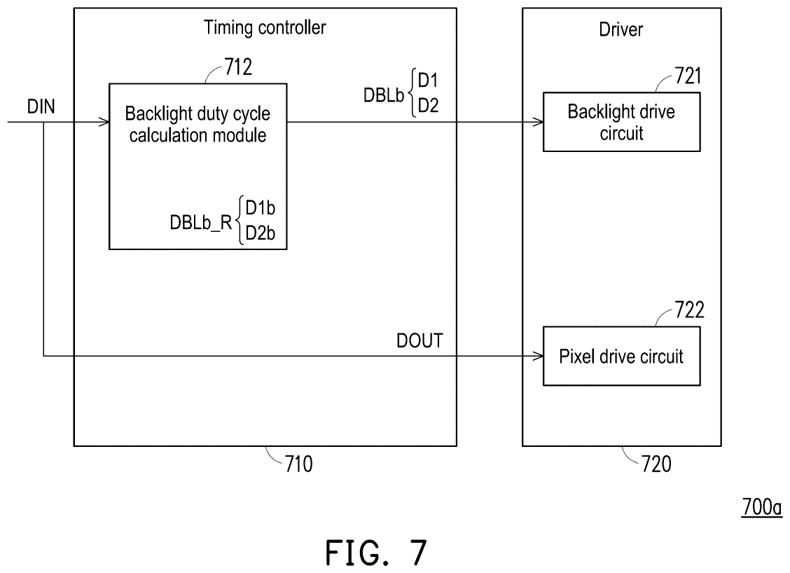

FIG. 7 is a circuit block diagram of a driving device according to another embodiment of the disclosure. Referring to FIG. 7, the driving device 700a includes a timing controller 710 and a driver 720. The driver 720 includes a backlight driving circuit 721 and a pixel driving circuit 722. The timing controller 710, the driver 720, the backlight driving circuit 721 and the pixel driving circuit 722 may be understood by reference to the relevant descriptions of the driving device 100a.

In the embodiment of FIG. 7, the timing controller 710 further includes a backlight duty cycle calculation module 712. The backlight duty cycle calculation module 712 may be, for example, implemented in firmware or software, and has access and calculation functions.

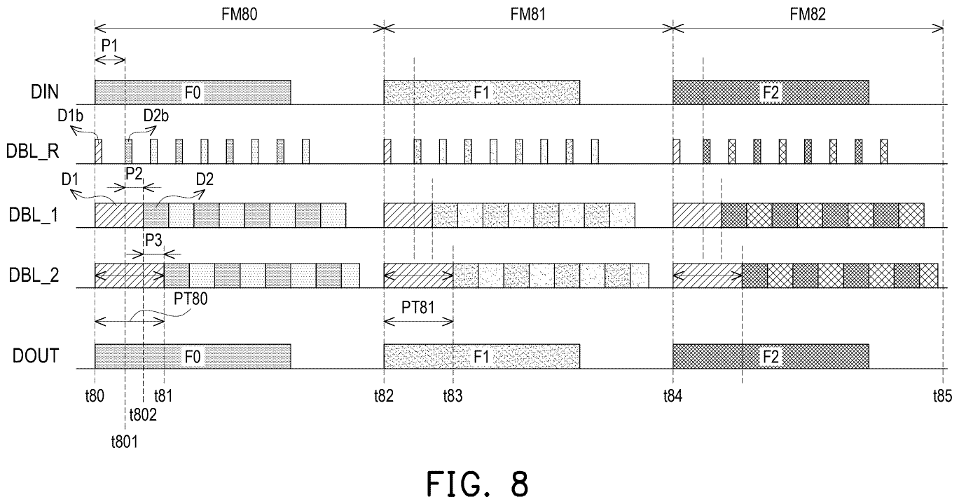

Referring concurrently to FIG. 8, FIG. 8 is a schematic diagram of the operation of the driving device according to the embodiment of FIG. 7 of the disclosure. In FIG. 8, the horizontal axis represents the operation time of the driving device 700a, and the vertical axis represents the voltage values of various data and/or signals of the driving device 700a.

In the embodiments of FIG. 7 and FIG. 8, in each frame cycle FM80 to FM82, the driving device 700a sequentially drives a single area of the display panel (e.g., the area A1 shown in FIG. 1A) according to various image data DOUT and DBLb required for multiple rows in this area, to achieve the application of local dimming.

In the frame cycle FM80 (i.e., time t80 to t82), at time t80, the timing controller 710 receives input image data DIN (i.e., image data represented by “F0”). In addition, the timing controller 710 calculates the backlight duty cycle data DBLb_R according to the input image data DIN through the backlight duty cycle calculation module 712 to generate the backlight image data DBLb.

In this embodiment, the backlight image data DBLb includes dummy data D1 and valid data D2. In the frame cycle FM80, the dummy data D1 is pre-configured before the valid data D2.

Specifically, at time t80, the backlight duty cycle calculation module 712 starts to calculate the output of the backlight duty cycle data DBLb_R. At time t801, the backlight duty cycle calculation module 712 completes the calculation operation to output the backlight duty cycle data DBLb_R. The backlight duty cycle data DBLb_R may be, for example, a part of the backlight image data DBLb.

In this embodiment, the backlight duty cycle data DBLb_R includes duty cycle data (e.g., at least one first duty cycle data D1b) corresponding to the dummy data D1 and duty cycle data (e.g., multiple second duty cycle data D2b) corresponding to the valid data D2. The first duty cycle data D1b is pre-configured before the second duty cycle data D2b. These duty cycle data D1b and D2b respectively indicate multiple duty cycles of multiple duty cycles of multiple backlight units disposed on adjacent and different rows in the area A1.

For example, taking the area A1 shown in FIG. 1A as an example, the first duty cycle data D1b indicates the duty cycle of multiple backlight units disposed on the first row in the area A1, and indicates that these backlight units do not emit light and are blocked. The second duty cycle data D2b indicates the duty cycle of multiple backlight units disposed on the second row in the area A1, and indicates that these backlight units emit light, and so forth.

In the frame cycle FM80, at time t801, the timing controller 710 transmits the generated backlight image data DBLb to the driver 720. Next, the driver 720 drives the backlight circuit (e.g., the backlight circuit BLC shown in FIG. 1A) according to the backlight image data DBLb.

Specifically, at time t801, the timing controller 710 outputs the backlight duty cycle data DBLb_R and the backlight image data DBLb to the driver 720.

At time t802, the driver 720 receives the above-mentioned image data DBLb_R and DBL. The aforementioned received image data DBL_R and DBL may be, for example, represented by backlight image data “DBLb_1”. In addition, the driver 220 further outputs the received backlight image data DBL (i.e., backlight image data “DBLb_1”) to the backlight driving circuit 721.

At time t81, the backlight driving circuit 821 receives the above-mentioned backlight image data DBL. The aforementioned received backlight image data DBL may be, for example, represented by backlight image data “DBLb_2”. In addition, the backlight driving circuit 821 is enabled to drive the backlight circuit (e.g., the backlight circuit BLC shown in FIG. 1A) according to the backlight image data DBL (i.e., the backlight image data “DBLb_2”).

It should be noted that in the frame cycle FM80, starting from time t0, during a delayed interval (i.e., the interval PT80), the driver 820 does not drive the backlight circuit (e.g., the backlight circuit BLC shown in FIG. 1A) according to the dummy data D1 in the backlight image data DBLb (i.e., the backlight image data “DBb_2”).

In the frame cycle FM80, after a delayed interval (i.e., the interval PT80) starting from time t0, that is, at time t81, the driver 820 drives the backlight circuit according to the valid data D2 in the backlight image data DBLb (i.e., the backlight image data “DBb_2”).

At the same time, at time t81, the timing controller 710 takes the input image data DIN as the output image data DOUT (i.e., the image data represented by “F0”), and transmits the output image data DOUT to the driver 720. In this way, at time t81, the driver 720 further receives the output image data DOUT through the pixel driving circuit 722, and enables the driving of the pixel circuit (e.g., the pixel circuit PXC shown in FIG. 1A) based on the output image data DOUT.

That is, at time t81, in addition to driving the backlight circuit according to the valid data D2 in the backlight image data DBLb, the driver 720 further simultaneously drives the pixel circuit according to the output image data DOUT. These data D2 indicate the grayscale data required for the same frame cycle FM80 (i.e., the image data represented by “DIN_0”), and indicate that multiple backlight units and multiple pixel units disposed in the same area respectively emit corresponding light. Therefore, at time t81, the backlight image data DBLb and the output image data DOUT operated by the driver 720 match each other.

In this embodiment, the delayed interval PT80 in the frame cycle FM80 is smaller than the single frame cycle FM80. Specifically, the delayed interval PT80 includes multiple intervals P1 to P3. The interval P1 (i.e., time t80 to t801) may be, for example, the time duration which the backlight duty cycle calculation module 712 calculates the backlight duty cycle data DBLb_R.

In this embodiment, the interval P2 (i.e., time t801 to t802) may be, for example, the time duration which the timing controller 710 transmits the calculated backlight duty cycle data DBLb_R and the backlight image data DBLb to the driver 720. That is, the interval P2 includes the transmission time for the timing controller 710 to output the backlight duty cycle data DBLb_R and the backlight image data DBLb to the driver 720 and the reaction time required for the driver 720 to receive the aforementioned data DBLb_R and DBLb. In this way, at time t802, the driver 720 obtains the backlight image data DBLb including the backlight duty cycle data DBLb_R (i.e., the backlight image data “DBLb_1”).

In this embodiment, the interval P3 (i.e., time t802 to t81) may be, for example, the time duration which the driver 720 transmits the backlight image data DBLb to the backlight circuit to enable the backlight circuit. That is, the interval P3 includes the transmission time for the backlight driving circuit 721 to output the backlight image data DBLb to the backlight circuit, and the reaction time required for the backlight circuit to be lit based on the backlight image data DBLb. In this way, at time t81, the backlight driving circuit 721 starts driving the backlight circuit according to the backlight image data DBLb including the backlight duty cycle data DBLb_R (i.e., the backlight image data “DBL_2”).

It should be noted that at time t80 to t81 (i.e., interval PT80), the backlight driving circuit operates according to the dummy data D1 in the backlight image data DBLb (i.e., the backlight image data “DBLb_2”) to block the target backlight unit. At the same time, the pixel driving circuit 722 operates according to the output image data DOUT. In this way, during this interval PT80, the backlight driving circuit 721 is not driven, thereby preventing the backlight image data from the previous frame cycle from affecting the operation of the present pixel driving circuit 722.

For example, in the continuous frame cycles FM80 to FM81, it is assumed that the image of the area is switched from a white image to a black image. In the frame cycle FM81, in the interval PT81, the driver 720 operates according to the dummy data D1 in the backlight image data DBLb (i.e., the backlight image data “DBLb_2”) so that the backlight unit is blocked. At the same time, the driver 720 operates according to the output image data DOUT indicating black (i.e., the image data represented by “F1”) so that the pixel unit appears black. In this way, at the starting phase of the new frame cycle FM81 (i.e., interval PT81), the backlight image data DBLb and the output image data DOUT synchronously correspond to the same black image, without simultaneously corresponding to both white and black images, thus preventing the occurrence of afterimages.

In this embodiment, the operation of the driving device 700a in other frame cycle FM81 (i.e., time t82 to t84) and frame cycle FM82 (i.e., time t84 to t85) may be understood by reference to the relevant descriptions of the frame cycle FM80.

In this embodiment, the timing controller 710 sets the duty cycle data corresponding to the dummy data D1 according to the input image data DIN required for each frame cycle FM80 to FM82, thereby setting the interval (e.g., the interval PT80 or PT81) for which the backlight circuit is delayed in activation during each frame cycle FM80 to FM82. In other embodiments, the delayed intervals PT80 and PT81 are the same preset interval.

In summary, the driving device for driving the display panel according to the embodiment of the disclosure provides output image data to the driver after a delayed interval through the timing controller, and may drive the area of the display panel according to the matching output image data and backlight image data, thereby preventing afterimages due to mismatching of these image data from appearing. Alternatively, through the generation of backlight image data including dummy data by means of a timing controller, the driving device is capable of not driving the backlight circuit for a delayed interval based on the dummy data, thereby preventing the backlight image data corresponding to the previous frame cycle from remaining, which would otherwise result in afterimages.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

1. A driving device suitable for driving a display panel, comprising:
a driver, coupled to a pixel circuit and a backlight circuit of the display panel; and
a timing controller, coupled to the driver, comprising a buffer, wherein the buffer is configured to store input image data corresponding to at least one area of the display panel during a frame cycle,
wherein the timing controller outputs output image data to the driver according to the input image data after a delayed interval, and the driver simultaneously drives a pixel circuit according to the output image data and drives the backlight circuit according to backlight image data generated based on the input image data,
wherein the delayed interval is set according to the input image data required for each frame cycle and comprises time duration which the timing controller calculates the backlight duty cycle data, time duration which the timing controller transmits the backlight duty cycle data to the driver, and time duration which the driver transmits the backlight image data to the backlight circuit to enable the backlight circuit.

2. The driving device according to claim 1, wherein the delayed interval is less than or equal to the frame cycle.

3. The driving device according to claim 1, wherein in the frame cycle, the timing controller is configured to calculate backlight duty cycle data according to the input image data to generate the backlight image data.

4. The driving device according to claim 3, wherein in the frame cycle, after the delayed interval, the driver drives the backlight circuit according to the backlight image data, and the timing controller accesses the buffer to output the input image data as the output image data.

5. (canceled)

6. The driving device according to claim 1, wherein the buffer is configured to store the input image data in a first frame cycle,
wherein in a second frame cycle after the first frame cycle, the timing controller is configured to calculate backlight duty cycle data according to the input image data to generate the backlight image data, and to calculate the output image data according to a compensation lookup table, the input image data and the backlight duty cycle data.

7. The driving device according to claim 6, wherein in the second frame cycle, the timing controller is configured to calculate gain data according to the compensation lookup table and the backlight duty cycle data, and to access the buffer to calculate the output image data according to the input image data and the gain data.

8. A driving device suitable for driving a display panel, comprising:
a driver, coupled to a pixel circuit and a backlight circuit of the display panel; and
a timing controller, coupled to the driver, configured to calculate backlight image data and output image data according to input image data corresponding to at least one area of the display panel during a frame cycle, wherein the backlight image data comprises dummy data and valid data,
wherein in the frame cycle, the driver drives the backlight circuit according to the valid data after an interval based on the dummy data when the driver drives the pixel circuit according to the output image data.

9. The driving device according to claim 8, wherein in the frame cycle, the dummy data is pre-configured before the valid data.

10. The driving device according to claim 8, wherein in the frame cycle, the timing controller is configured to calculate backlight duty cycle data according to the input image data to generate the backlight image data, wherein the backlight duty cycle data comprises first duty cycle data corresponding to the dummy data and second duty cycle data corresponding to the valid data.

11. The driving device according to claim 8, wherein in the frame cycle, the interval based on the dummy data comprises time duration which the timing controller calculates the backlight duty cycle data, time duration which the timing controller transmits the backlight duty cycle data to the driver, and time duration which the driver transmits the backlight image data to the backlight circuit to enable the backlight circuit.
